(19) United States
(12) Patent Application Publication
(10) Pub. No.: US 2011/0211570 A1
(43) Pub. Date: Sep. 1, 2011

(54) SYNCHRONIZATION OF NETWORK DEVICES

(75) Inventor: Andreas HEINRICH, Munich (DE)

(73) Assignee: Siemens Aktiengesellschaft, Munich (DE)

(21) Appl. No.: 13/035,685

(22) Filed: Feb. 25, 2011

(30) Foreign Application Priority Data
Feb. 25, 2010 (DE) 102010002331.0

(51) Int. Cl. H04J 3/06

(52) U.S. Cl. 370/350; 370/503

(57) ABSTRACT

A synchronized communication protocol based on time slots is used for wireless data transmission. Synchronization data are received for each network device by an additional receiver which has a lower energy requirement in comparison with the transmitting and/or receiving unit. To specify an energy-efficient and, at the same time, robust solution to the synchronization, at least two bits are used for each synchronization signal, as a result of which the synchronization signals can be distinguished from, e.g., interferences or the susceptibility to interference can at least be distinctly reduced.

### CROSS REFERENCE TO RELATED APPLICATIONS

This application is based on and hereby claims priority to German Application No. 102010002331.0 filed on Feb. 25, 2010, the contents of which are hereby incorporated by reference.

### BACKGROUND

Described below is a method for the synchronization of network devices of a network, in which a synchronized communication protocol based on time slots is used for each network device for the wireless data transmission by a transmitting and/or receiving unit, synchronization data with at least one synchronization signal being transmitted by at least one synchronizer and the synchronization data being received for each network device by an additional receiver which has a lower energy requirement in comparison with the transmitting and/or receiving unit. Also described below are a network device and to a synchronizer by which a generic method can be carried out.

Such a method is used, in particular, in the field of industrial automation technology. The machine-to-machine communication forms a central part of computer-aided automation systems. Compared with wire-connected systems, wireless communication systems offer advantages, in particular with regard to the flexibility. This characteristic is also increasingly required in the industrial environment in order to be able to respond as rapidly and cost-effectively as possible to changed conditions. In particular, the installation of an infrastructure (cables, base stations, power system) is frequently not cost effective or not possible at all. In addition, an infrastructure must be planned before it is installed and usually restricts the use of the communication system greatly to the planned application scenario. A change in the application therefore also frequently requires changing the infrastructure (e.g. in the case of spatial relocation/alteration of a production line) and thus causes high costs.

A special optimization potential in cost reduction is offered by battery-operated wireless mesh networks (also called sensor networks) which do not require any infrastructure for the communication or the power supply. Apart from savings in existing systems, the use of such networks also offers the potential for exploiting new fields of application which, due to inadequate flexibility or the infrastructure required, cannot be made to measure or not covered at all with previous systems. However, the network elements must be as advantageous as possible to procure (CAPEX, “CAPital EXpenditure”), and at the same time, must only cause low operating/maintenance costs (OPEX, “OPerational EXpenditure”). This can be achieved by the most optimal use of the radio resources with, at the same time, the lowest possible energy consumption and advantageous hardware of the network elements.

Industrial applications can often process data, e.g. in a control process, appropriately only if they have a certain degree of predictability (determinism). Even if an application can be adapted to the delay conditions, slight and deterministic delays usually offer advantages in the automation since response times and control loops can be better optimized. The wire-connected systems used to date such as, e.g., Profibus and Profinet therefore offer special methods for ensuring the highest possible degree of determinism for the data transmission.

Ideally, wireless systems should also offer the highest possible degree of determinism in the transmission. In contrast to wire-connected systems, however, the transmission channel is distinctly more subject to interference in wireless transmission and can thus increasingly cause transmission problems. To achieve a high transmission quality or even one similar to a wire-connected system, a wireless system must therefore be constructed to be sufficiently robust against interfering influences. This applies especially to industrial environments which usually have much more difficult transmission conditions than applications in telecommunication. For fields of application in an industrial environment, an essential optimization potential for wireless systems is implementing the transmission as deterministically as possible and at the same time robustly.

A high degree of determinism can be implemented by transmission methods such as the “time division multiple access” (TDMA) in which the channel is subdivided into time slots which are in each case assigned to one pair of nodes (transmitter and receiver). The time slots are assigned in such a manner that no or as few as possible collisions arise during the communication and thus very little energy is required for repeated transmissions. This characteristic becomes increasingly positively noticeable especially in the case of high traffic loads. In addition, the small number of collisions makes it possible to optimally utilize the capacity of the channel. Due to the reservation of slots, the nodes (network devices) also know the times at which they must be active. For this reason, very efficient energy saving strategies can be implemented in which a node changes to a sleep mode when a slot is not reserved for it. As a result, only the pair of nodes for which a slot is reserved is active during the slot. All other nodes can sleep during this time.

The prerequisite for using a TDMA-based media access is a sufficiently accurate synchronization of the nodes with one another. It is only when the synchronization does not exceed a previously planned tolerance that an interference between the slots can be excluded controllably. In general it applies that a higher accuracy of synchronization leads to smaller tolerances and thus to a lower energy consumption.

In the synchronization of TDMA-based wireless sensor networks, two principles can be distinguished. One is an in-band synchronization in which synchronization data are transmitted via the same channel in which the useful data are also transmitted. In the present context, this means that the same transceiver unit is used, i.e. this is also called in-band synchronization if the useful data and synchronization data are transmitted on different channels (time slots) but with the same transceiver unit.

In this approach, the protocol stack of the network node ensures that the management packets for the synchronization are distinguished from (useful) data and conducted to the correct processing units in the node. The transmitting and processing of in-band management data results in an additional overhead. Since the same transceiver unit is used, the energy requirement for transmitting a bit for the synchronization is equal to the transmission of a data bit (or possibly not equal but always of the same order of magnitude).

Modern transceivers are optimized for the transmission of data streams and usually require a high-quality modulation and a comparatively complex pre- and postprocessing of the signals in order to achieve transmission rates suitable for practicable applications and good robustness. The required hardware requires power of the order of magnitude of several milliwatts. Chips used in practice—such as, e.g., the CC2420 by Texas Instruments—have, for example, a power consumption of approx. 60 mW. If very long service lives are to be achieved with battery-operated network elements, the active time (duty cycle: time in which the transceiver is activated and consumes power) must therefore be reduced to such an extent that the average power consumption is so low that the service live aimed for is achieved with the given battery capacity. There is a direct relationship between the power consumption and the number of bits which can be exchanged: the greater the power consumption the fewer bits can be transmitted. Using the chips mentioned, usually only a few management or useful data items can thus be transmitted per day in practice.

The WirelessHART standard, for example, defines an in-band synchronization. To minimize the overhead, the synchronization information items are embedded in the useful data packets. In the case of very large periods for the useful data, however, separate packets must be regularly generated for the synchronization (“keep alive”) in order to compensate for the drifting of the clocks. In the hardware defined for WirelessHART, the synchronization periods are of the order of magnitude of 0.5-1 minute. If generally available hardware having a greater drift is used, a distinctly more frequent (re-) synchronization is therefore required. For systems having a very long period for the data transmission, this results in a comparatively high energy demand for synchronizing the network.

The second principle is an out-band synchronization as known from RT link, a TDMA-based system (A. Rowe, R. Mangharam and R. Rajkumar, “RT link: A time-synchronized link protocol for energy-constrained multi-hop wireless networks”, in “Sensor and Ad Hoc Communications and Networks”, Third Annual IEE Communications Society Conference on Sensor, Mesh and Ad Hoc Communications and Networks, Vol. 2, p. 404-411, 2006). For this purpose, the nodes (network devices) to be synchronized have additional (low-power) receivers which can receive synchronization pulses. On reception of a pulse, the main processor is informed via a pin. Following this, the local clock of the node is initialized and a slot-based communication phase is initiated. The deciding factor for a successful separation of the slots is that the synchronization drift can be compensated for by corresponding guard times up to the last slot. In general, the number of possible slots is thus limited by the guard times or the drift, respectively. The reliability of the system is decisively determined by the successful transmission of the synchronization pulses for initiating the communication phase. If the pulse is not detected, e.g. due to interference—high interference components having to be expected especially in industrial environments—, the subsequent frame will not be processed. Even if the system could process the frame without pulse, a cycle should only be so long that the system has not yet lost synchronization at this time. This can be ensured only with great difficulty or not at all with increasingly long periods. In addition, the failure of a frame is increasingly problematic in the case of very long periods since the buffered data cannot be forwarded and thus long delays are generated if they can be transmitted only in the next frame. In the case of RT link, a frame can thus be processed only when the synchronization pulse has been successfully transmitted.

In out-band synchronization, synchronization data are thus transmitted via a separate channel. In the present context, this means that a separate transceiver unit and receiver unit, respectively, is used. The transmission of the synchronization data occurs in parallel with the data transmission and has no influence on the available channel capacity for useful data. The energy requirement for the transmission of the synchronization bit is essentially determined by the separate transceiver or receiver, respectively, and the associated processing hardware. When using low-power receivers for receiving the synchronization information in a node, a very energy-efficient synchronization and thus high service life can thus be achieved. This applies, in particular, to the case of cost-effective hardware components. Since such receivers usually have a comparatively high clock drift, they require a distinctly shorter synchronization period in comparison with the data period and would thus require more energy for the synchronization than for the data transmission when in-band synchronization is used.

Signaling via a separate (out-band) channel was originally used in sensor networks for the energy-efficient media access in asynchronous networks. If a node wishes to communicate with another node, it initially sends a wake-up signal via the out-band channel which is received by the corresponding receivers in the other nodes (also called wake-up receivers). The wake-up receiver thereupon generates a wake-up pulse and the node goes into standby for reception with the main receiver. By this approach, the energy-intensive idle listening of the main receiver is substituted by an energy-efficient idle listening of the wake-up receiver.

In order to keep the energy requirement in low-power receivers as low as possible, a very simple structure having only a few active electronic components is normally used. As a result, only very few data can be coded in the signal. In the case of currently used implementations, only one bit (“0” and “1” states) is available. This leads to all nodes also being woken up, e.g., in asynchronous networks.

At present, work is being conducted on low-power receivers which provide for the transmission of several bits or higher-valued symbols (more than two states). These are used in networks having an asynchronous communication protocol for the purpose of waking up only certain nodes in the network for the reception of useful data, see also, e.g. U.S. Pat. No. 7,209,771 B2.

### SUMMARY

An aspect of the method is specifying an energy-efficient and, at the same time, robust solution for the synchronization of networks with a synchronized communication protocol.

In a method of the type initially mentioned, this aspect is achieved in that at least two bits are used for each synchronization signal.

The solution uses low-power transmitters and receivers with the potential for transmitting more data than only one bit—i.e. one pulse—for the synchronization of a network with a synchronized communication protocol based on time slots. In distinction from the related art described, the data are thus not used for supporting asynchronous communication protocols, for example for the deliberate waking-up of certain communication partners, but for supporting synchronized communication protocols which provides for a more robust detection of the synchronization information items in the environment of other interference signals, in comparison with the previously known system for out-band synchronization.

The network devices (nodes) may evaluate synchronization data received by the additional receiver (the low-power receiver), which synchronization data are transmitted by a synchronizer during the performance of the method, can be implemented, e.g., by an evaluating routine running in the main processor. This also allows more complex evaluations without requiring the high energy demand of an in-band synchronization since the energy demand of the processor is less by orders of magnitude than the transmission via the main transceiver. As a result, the advantages of an in-band synchronization (use of synchronization data having more than one bit) are combined with those of an out-band synchronization (energy-efficient signal transmission).

Thus, the synchronization signals consisting of more than one bit can be unambiguously distinguished with great advantage from interferences so that there is no synchronization to interference detected erroneously as synchronization signal (pulse) or, respectively, a synchronization pulse cannot be detected by interference. The method, together with the network device and synchronizer are thus particularly suitable for use in industrial environments in which high interference components can often be expected. A relatively high robustness in the synchronization is a prerequisite for appropriately operating such systems in difficult environments—as are normal in industrial automation. An out-band synchronization with a single synchronization pulse as known from the related art would scarcely be achievable here since the probability for the disturbance of single synchronization pulses would be too high and, in addition, other interference signals could bring the system into an undefinable state. The method solves this problem or at least reduces the susceptibility to interference distinctly.

### DETAILED DESCRIPTION OF THE PREFERRED EMBODIMENT

In an advantageous form of the embodiment, at least one network device is used as synchronizer, the synchronization data being transmitted by an additional transmitter which has a lower energy requirement in comparison with the transmitting and/or receiving unit. Due to the fact that the function of a synchronizer has been taken over by one or more network devices (nodes), no separate synchronizer is needed in the network.

In this context, the additional transmitter with the additional receiver is advantageously integrated in a second transmitting and receiving unit in the network device. Apart from the main transceiver for the (useful) data transmission, the network device thus contains an additional low-power transceiver for transmitting and receiving the synchronization data.

In a further advantageous embodiment, at least one synchronizer transmits synchronization data by which it can be identified. This is particularly appropriate when a number of synchronizers are used in the network, the transmitting ranges of which overlap at least partially. In this case, it may happen that network devices receive synchronization data from more than one synchronizer, the synchronization source of the respective synchronization data being identifiable by the evaluating routine.

In a further advantageous embodiment, at least one network device is allocated a synchronizer which is identified from the synchronization data by the network device, only the synchronization signals of the associated synchronizer being used for synchronization by the network device. Thus, the synchronization data are designed in such a manner that the nodes can discriminate between the signals and only use the synchronization information intended for them so that at least certain nodes only use previously determined synchronization sources for the synchronization.

In a further advantageous embodiment, the synchronization data are transmitted by a centralized synchronizer. In this embodiment, which is appropriate for manageable networks in which all nodes are located within the transmitting range of the centralized synchronizer, additional synchronization data for identifying the synchronization source can thus also be omitted.

In a further advantageous embodiment, the synchronization data are designed with a coding redundancy. This makes it possible to achieve that, in the case of small transmission errors, at least the synchronization signal can be reconstructed which further increases robustness of the synchronization.

In a further advantageous embodiment, the communication protocol supports a frame-based communication. As a result, protocols used widely particularly in automation technology can be used. A possible implementation is a largely standard-compliant WirelessHART system in which the in-band synchronization is replaced by a low-power out-band synchronization. An expansion of existing systems such as, for example, WirelessHART provides for products which offer a certain degree of standard-compatibility (e.g. for data communication) and are largely identical in the development and production but provide distinctly higher service lives of the system in certain fields of application—such as, e.g., with little data volume in monitoring applications.

In a further advantageous embodiment, the communication protocol supports a parallel use of different frame sizes. This option, too, is given, e.g., in a largely standard-compliant WirelessHART which supports scheduling with different frame sizes.

In a further advantageous embodiment, the frames to be used are controlled with the synchronization data during the data transmission. As a result, e.g. the switching-on and -off would be achievable, as supported, e.g., by WirelessHART, and could avoid management overhead via the main transceiver.

In a further advantageous embodiment, the communication protocol, for determining the start of a frame, administers a slot number by which, together with the frame size, the current slot can be determined in a frame. This feature, too, is given in WirelessHART, the slot number corresponding to the “Absolute Slot Number (ASN)”.

In a further advantageous embodiment, with the synchronization data, information items are transmitted by which the slot number can be generated. In the simplest case, (at least) a part of the slot number—e.g. the lower bits of the ASN—is transmitted for this purpose.

In a further advantageous embodiment, the slot number is generated in at least one network device and the slot number is also counted in a slot number counter. In this manner, a node can receive or generate the slot number and allow, for example, an ASN counter in the node to run synchronously, which generates corresponding wake-up signals for the main transceiver to the active slots.

In a further advantageous embodiment, the synchronization data are transmitted more frequently than required due to a calculated guard time for compensating for a synchronization drift. Due to the frequent transmitting, a redundancy is created but the data allow a precise generation of the synchronization signal as a result of which the robustness of the method is increased even further. If the node carries out, for example, an internal counting of the ASN, the latter is always calibrated when synchronization data have been successfully received. By the ASN in the data, the node can determine the absolute slot position in a simple manner.

In a particularly advantageous form of the embodiment, the evaluation in network devices is performed at least partially by evaluation hardware which has a lower energy requirement in comparison with the main processor. This can be achieved, e.g., by an energy-efficient hardware-based logic of simple registers and comparison operations. With simple coding, at least large parts of the evaluation can thus be diverted into energy-saving hardware whereas more complex evaluations are handled by the main processor. Due to the at least partial implementation of simple evaluation hardware, further energy optimization is achieved.

When a (separate) synchronizer is used, it is not absolutely necessary that it has a low-power transmitter if it has, for example, a power supply. Strictly speaking, this naturally also applies to network devices but the method is specially aimed at an energy-optimized and yet robust synchronization even if some nodes in the network do not depend on this.

In an advantageous form of the embodiment, the synchronizer also has a receiver for receiving the synchronization data. As a result, synchronization data from another synchronizer can be received, e.g., and effectively forwarded (transmitted) to increase the range.

In a further advantageous embodiment, the transmitter with the receiver is integrated in a transmitting and receiving unit.

In a further advantageous embodiment, the synchronizer has an additional transmitting and/or receiving unit for the wireless data transmission by using a synchronized communication protocol based on time slots. As a result, it can also transmit its own useful data or forward useful data from nodes.

In the case where the method is implemented in a largely standard-compliant Wireless HART system, one is provided effectively with an ultra-low-power WirelessHART-based system with robust out-band synchronization. If a special energy-efficient evaluating logic is used for the network devices, this could also be called an extreme-ultra-low-power WirelessHART system. In all cases, the robustness of the synchronization method can be increased further by special embodiments having, e.g., time redundancy or coding redundancy.

In summary, the method relates to an energy-efficient synchronization of network devices, wherein a synchronized communication protocol based on time slots is used for the wireless data transmission and wherein the synchronization data are received for each network device by an additional receiver which has a lower energy requirement in comparison with the transmitting and/or receiving unit. In order to specify an energy-efficient and, at the same time, robust solution for the synchronization, it is proposed that at least two bits are used for each synchronization signal, as a result of which the synchronization signals can be distinguished from, e.g., interferences or, respectively, the susceptibility to interference can at least be distinctly reduced.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for synchronization of network devices in a network, comprising:
transmitting by at least one synchronizer, for a synchronized communication protocol based on time slots used for each network device for wireless data transmission by a transmitting and/or receiving unit, synchronization data with at least one synchronization signal, the synchronization data being received for each network device by a low-energy receiver having a lower energy requirement than the transmitting and/or receiving unit, and at least two bits are used for each synchronization signal.

2. The method as claimed in claim 1, wherein at least one network device is used as the at least one synchronizer, and
wherein the synchronization data are transmitted by a low-energy transmitter which has a lower energy requirement than the transmitting and/or receiving unit.

3. The method as claimed in claim 1, wherein the at least one synchronizer transmits the synchronization data by which the at least one synchronizer can be identified.

4. The method as claimed in claim 3, wherein at least one network device is allocated the at least one synchronizer which is identified by the network device using only the synchronization signals of the at least one synchronizer allocated to the network device.

5. The method as claimed in claim 1, wherein the synchronization data are transmitted by a centralized synchronizer.

6. The method as claimed claim 5, wherein the synchronization data have a coding redundancy.

7. The method as claimed claim 6, wherein the communication protocol supports frame-based communication.

8. The method as claimed in claim 7, wherein the communication protocol supports a parallel use of different frame sizes.

9. The method as claimed in claim 8, wherein the frames to be used are controlled with the synchronization data during the data transmission.

10. The method as claimed in claim 9, wherein the communication protocol, for determining the start of a frame, administers a slot number by which, together with a frame size, a current slot can be determined in a frame.

11. The method as claimed in claim 10, wherein, with the synchronization data, information items are transmitted by which the slot number can be generated.

12. The method as claimed in claim 11, further comprising:
generating the slot number in at least one network device; and
counting the slot number is in a slot number counter.

13. The method as claimed claim 12, wherein the synchronization data are transmitted more frequently than required due to a calculated guard time for compensating for a synchronization drift.

14. A network device, comprising:
at least one main processor, with a local clock;
a first transmitting and/or receiving unit for wireless data transmission using a synchronized communication protocol based on time slots; and
an additional receiver, having a lower energy requirement than said first transmitting and/or receiving unit, receiving and evaluating synchronization data with at least one synchronization signal, each synchronization signal having at least two bits.

15. The network device as claimed in claim 14, further comprising an additional transmitter, having a lower energy requirement than said transmitting first and/or receiving unit and transmitting the synchronization data.

16. The network device as claimed in claim 15, wherein said additional transmitter and said additional receiver are integrated in a second transmitting and receiving unit.

17. The network device as claimed in claim 14, wherein said additional receiver includes a slot number counter.

18. The network device as claimed in claim 17, wherein said additional receiver includes evaluation hardware which has a lower energy requirement than said at least one main processor.

19. A synchronizer for wireless data transmission with a first transmitting and/or receiving unit using a synchronized communication protocol based on time slots by transmitting synchronization data from the synchronizer to a low energy receiver, having a lower energy requirement than the first transmitting and/or receiving unit, which receives and evaluates the synchronization data, the synchronizer comprising:
at least one transmitter transmitting the synchronization data with at least one synchronization signal, each synchronization signal having at least two bits.

20. The synchronizer as claimed in claim 19, further comprising a receiver receiving the synchronization data.

21. The synchronizer as claimed in claim 20, wherein the at least one transmitter and the receiver are integrated in a second transmitting and receiving unit.

22. The synchronizer as claimed in claim 21, wherein the at least one transmitting and/or receiving unit includes at least two transmitting and/or receiving units.
